(19) United States
(12) Patent Application Publication
(10) Pub. No.: US 2002/0165020 A1
(43) Pub. Date: Nov. 7, 2002

(54) Method of processing data for lotteries in automated lottery system

(76) Inventor: Takeshi Koyama, Tokyo (JP)

Correspondence Address: McGuire Woods, Tysons Corner, Suite 1800, 1750 Tysons Boulevard, McLean, VA, 22102-3915, US

(21) Appl. No.: 09/837,192

(22) Filed: Apr. 19, 2001

(30) Foreign Application Priority Data
Apr. 20, 2000 (JP) 119521/2000

(51) Int. Cl. G06F 19/00

(52) U.S. Cl. 463/17

(57) ABSTRACT

When being accessed by a lottery purchaser terminal through a communication network, the server obtains an identification of the terminal and stores the identification in a memory of the server. The identification is unique on the communication network and, for example, is an IP address assigned to the terminal. After the storing, the server transmits a menu of lotteries to the terminal to stimulate the purchaser to purchase a lottery. The purchaser determines a lottery which the purchaser wants to purchase in accordance with the menu, and submits a purchase offer into the server. Then the server carries out random sampling on the basis of predetermined distribution to generate a specific number for the lottery specified by the purchase offer. The server determines that the lottery is a winning lottery if the specific number meets a condition predefined for the predetermined distribution, while the lottery is a blank lottery if not. The server notifies the terminal whether the lottery is the winning lottery or the blank lottery.

### BACKGROUND OF THE INVENTION

This invention relates to an automated lottery system, and more particularly to methods for processing data for lotteries.

There are many kinds of lotteries in the world, which are provided in various types of lottery systems. In a primitive system, the purchasers purchase lottery tickets issued by the government, the local self-governing bodies, or the like, and waits the drawing of lottery winners. In another popularized system, purchasers of lotteries are required to use an intermediary who has access to a system data base to participate, and moreover, the intermediary is typically located in the street facility. Thus, the above-mentioned conventional systems require a large amount of physical distribution cost and put the purchasers to inconvenience for purchasing lotteries.

To solve the inconvenience at the conventional system, various kinds of approaches have been proposed. Almost all of the proposed approaches relate to semi- or partially-automated lottery system where purchasers have direct access to a system data base to purchase lotteries and are disclosed in, for example, U.S. Pat. No. 4,922,522 and Japan Patent Laid-Open Nos. H7-141447, H8-202785 and H11-102405, which are incorporated herein by reference. Other proposals have been made about techniques applicable to the lottery systems and arc disclosed in, for example, U.S. Pat. No. 5,815,577, Japan Patent Laid-Open No. H9-19535 and WO 95/26085, which are also incorporated herein by reference.

### SUMMARY OF THE INVENTION

In recent years, Internet technologies have remarkably developed and various new kinds of on-line business transactions are provided on the Internet However, the above-mentioned approaches and techniques are for already known business transactions, and do not devise new kinds of business transactions by themselves. It is therefore an object of the present invention to provide lottery-data processing methods which can devise new business transactions.

According to one aspect of the present invention, a data processing method is executed by a server which exists on a communication network and performs as an automated lottery machine. The server is connected with a terminal of a purchaser through the communication network, and has a memory. The terminal has an identification unique on the communication network.

In the method, responsive to access from the terminal, the server obtains the identification of the terminal to store the identification in the memory, and then transmits a menu of lotteries to the terminal to stimulate the purchaser to purchase a lottery When receiving from the terminal a purchase offer which is determined by the purchaser in accordance with the menu and which indicates a lottery of a purchase target, the server judges whether the lottery specified by the purchase offer is a winning lottery or a blank lottery, and notifies the terminal of a judgement of the lottery.

The communication network may stand on TCP/IP stacks, and the identification may be an IP address assigned to the terminal The terminal may be a mobile terminal with telephony function and may have a telephone number as the identification. All of the steps may be executed in on-line processing.

With the above method, the automated lottery system is provided as a new business transaction to the consumers or the purchasers. Additionally, the new business transaction needs no paper in essence, although it is not so limited to paperless systems.

These and other aspects of the present invention, as well as its advantages and features are described as preferred embodiments in more detail in conjunction with the text below and attached figures.

### BRIEF DESCRIPTION OF THE DRAWINGS

FIG. 1 is a schematic block diagram of lottery system in accordance with one embodiment of the present invention;

FIG. 2 is a schematic block diagram of a user terminal;

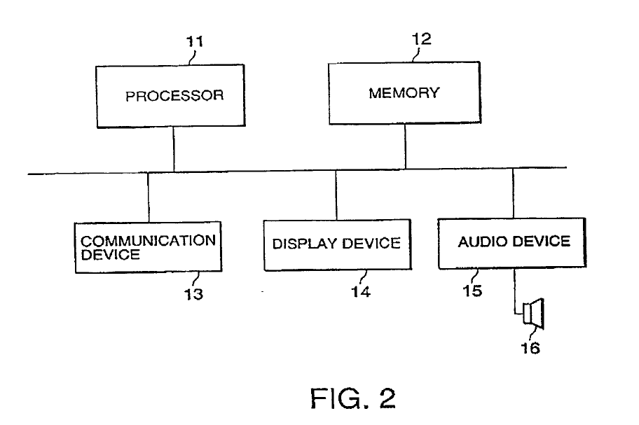

FIG. 3 is a schematic block diagram of a server,

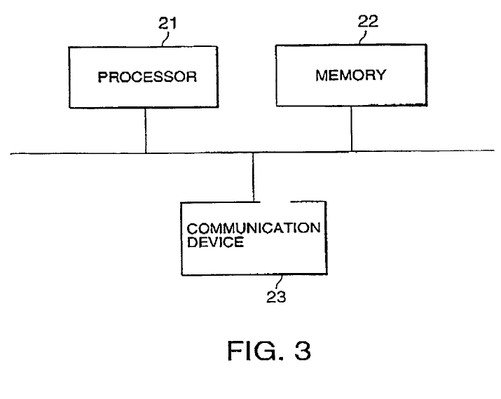

FIG. 4 is a chart diagram of operations in the lottery system in accordance with one embodiment of the present invention; and

FIG. 5 is an example view of a menu of lotteries.

### DESCRIPTION OF THE PREFERRED EMBODIMENTS

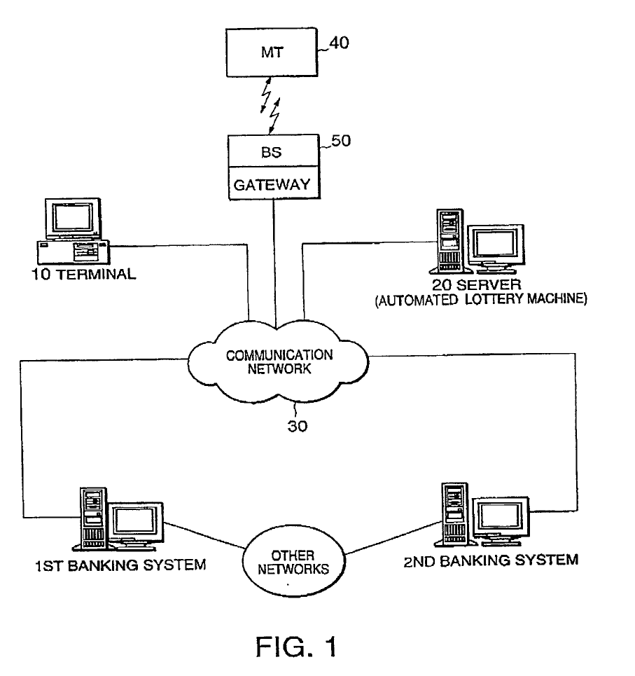

Referring to FIG. 1, a lottery system according to an embodiment of the present invention comprises a terminal 10 and a server 20 which are connected with each other through a communication network 30. In this embodiment, the communication network 30 stands on TCP/IP stacks, and is for example the Internet.

The terminal 10 comprises a processor 11, a memory 12, a communication device 13, a display device 14, and an audio device 15 with a speaker 16. The processor 11 works in cooperation with a program stored in the memory 12 and causes the terminal 10 to perform as a lottery purchasing apparatus. The memory 12 also serves as a temporal storage where the processor 11 stores temporal data during executing of the program. In this embodiment, the program includes a web browser application program, the terminal 10 serving as a web client terminal. The communication device 13 provides the terminal 10 with a function of communication via the communication network 30, and is for example a modem, an ADSL modem, a network card (NIC), a terminal adapter (TA), or a ISDN card. The display device 14 is for example a cathode ray tube (CRT) display device, or a liquid crystal display (LCD) device. The audio device 15 is for example an audio card.

In this embodiment, the terminal 10 is an exemplary personal computer system. Instead, a lottery purchaser may use a mobile terminal (MT) 40 as a lottery purchasing apparatus, if the mobile terminal 40 can execute operations described later or their equivalent operations which depends on network services available for the mobile terminal 40. The mobile terminal 40 is for example a personal data assistant (PDA) with telephony function, or a cellular phone which can perform on WAP (Wireless Application Protocol), Compact HTML, and so forth. The mobile terminal 40 is connected with the communication network 30 via a base station (BS)/gateway 50.

The server 20 comprises a processor 21, a memory 22, and a communication device 23. The processor 21 works in cooperation with a program stored in the memory 22 and causes the server 20 to perform as an automated lottery machine. The memory 22 also serves as a temporal storage where the processor 21 stores temporal data during executing of the program. In this embodiment, the program includes a web server application program, such as “Apache” or Microsoft IIS server, with CGI for determination of winning lottery. That is, the server 20 according to this embodiment provides the user terminal 10 with information or purchase offer request in the form of Web pages. The communication device 23 provides the server 20 with a function of communication via the communication network 30, and is for example a modem, a network card (NIC), a terminal adapter (TA), or a ISDN card. In this embodiment, the communication device 23 is normally activated, and therefore, the server 20 is accessible by terminal 10 with activated communication device 13.

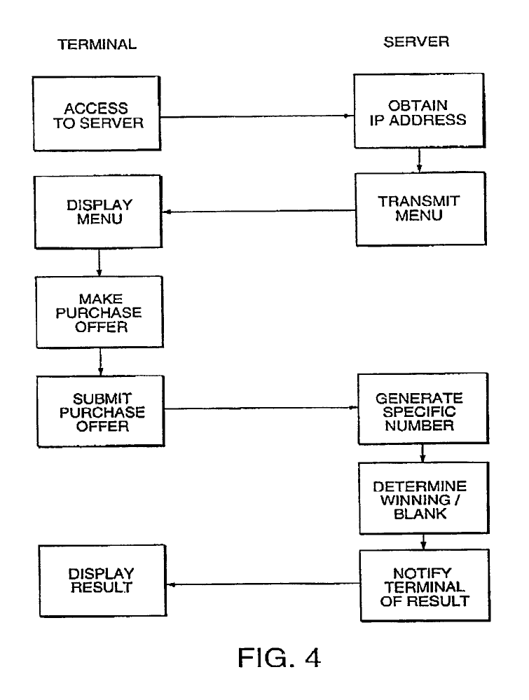

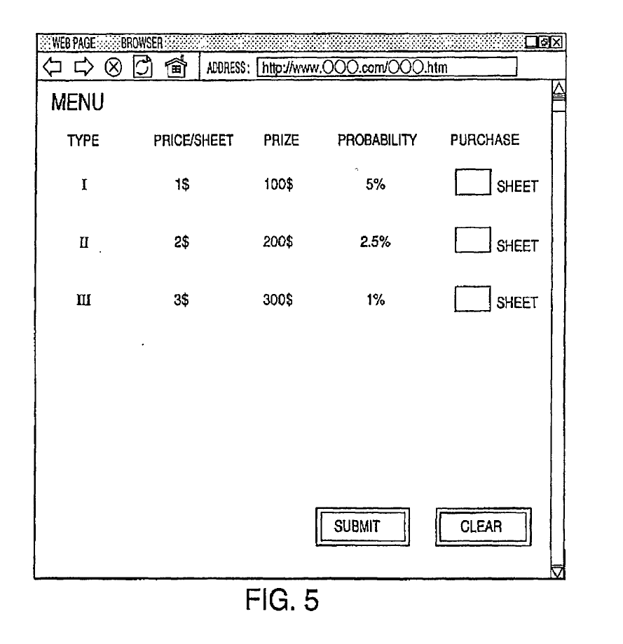

Now, detail explanations will be made about operations in the automated lottery system according to this embodiment, with also reference to FIGS. 4 and 5. In the following explanations, the processors 11 and 12 execute the respective programs stored in the memories 12 and 22, and cause the terminal 10 and the server 20 to perform the respective operations. In addition, the purchaser possessing the terminal 10 has a credit card which is designated as the purchaser's own bank a bank having a first banking system. The owner of the server 20, namely automated lottery system provider, has another bank having a second banking system.

In the terminal 10, the processor 11 starts the web browser program stored in the memory 12, then the web browser view is displayed on the display device 14. On the communication device 13 is activated, the purchaser enters UBL or jump instruction in the web browser view with an input device (not shown), such as a keyboard and a mouse, thereby the terminal 10 accesses to the server 20. At this time, since the web browser program of the terminal 10 performs on HTTP, the terminal 10 informs the server of the IP address which is of the terminal 10 and is unique on the communication network 30.

In response to the access from the terminal 10, the server 20 obtains the IP address of the terminal 10 as an identification of the terminal 10, and stores the IP address of the terminal 10 in the memory 22. Then, the server 20 transmits a menu of lotteries to the terminal 10 in order to stimulate the purchaser to purchase a lottery. An example of the menu of the lotteries is illustrated in FIG. 5, which is displayed as web browser view on the display device 14 of the terminal 10 when the menu is received by the terminal 10.

When the menu of the lotteries is displayed on the display device 14, the purchaser selects types of lotteries and determines their numbers of sheets in accordance with the menu, thereby making a purchase offer. In this embodiment, the purchaser wants to two sheets of type I lottery. The purchase offer is submitted to the server 20 when the purchaser clicks “Submit” button shown in the browser view with the mouse of the terminal 10. Also, the purchaser sends its credit card number to the server 20, in order for the owner of the server 20 to issue a bill and to pay a prize accompanying with transactions described below. For sending credit card number, data encrypting techniques may be applied and such techniques are disclosed in U.S. Pat. No. 5,815,577, which is incorporated herein by reference.

When receiving the purchase offer from the terminal 10, the server 20 judges, at every lotteries purchased by purchaser, whether the purchased lottery is a winning lottery or a blank lottery. At this time, the server 20 issues a bill for the purchase offer and submits the bill to the first banking system through the communication network 30. The bill issuing and submitting may be carried out later.

In detail, the server 20 at first carries out random sampling on the basis of sample number distribution to generate a specific number for each lottery which is specified with the purchase offer by the purchaser. The sample number distribution is predetermined for each of the types of lotteries, and is probability distribution, such as binominal distribution, a uniform distribution, Poisson distribution, beta distribution, Erlang distribution, gamma distribution, logarithmic normal distribution, exponential distribution, normal or Gaussian distribution, truncated normal distribution, triangular distribution. In this embodiment, the predetermined distribution for type I lottery is normal distribution where mean and standard deviation are zero and one, respectively, and the ninety-five percent of the sample numbers belong to the range of “0±2.” In the example operations of this embodiment, the specific number for a purchased lottery is 1.012 and the specific number for the other purchased lottery is 2.561.

After the generation of the specific numbers, the server 20 determines that the lottery is a winning lottery if the specific number meets a winning condition, while the lottery is a blank lottery if the specific number does not meets the winning condition. The winning condition is predefined on the basis of the predetermined sample number distribution and the winning probability at each type of lottery. In this embodiment, the winning condition of the type I lottery is that the specific number is greater than +2 or smaller than −2, so that the wining probability is five percent. In the example operations, the purchased lottery with the specific number of 1.012 is judged to be a blank lottery, while the other purchased lottery with the specific number of 2.561 is judged to be a winning lottery.

After the determination, the server 20 notifies the terminal 10 whether each of the lotteries is the winning lottery or the blank lottery. In the example operations, the server 20 notifies the terminal 10 that one lottery is the winning lottery and the other is the blank lottery. At this time, the server 20 sends a payment request for the second banking system through the communication network 30, such that the prize is paid from the second banking system to the first banking system through other network. Thus the purchaser gets the prize of the winning lottery on the account opened with the first banking system.

When receiving the notification from the server 20, the terminal 10 displays the lottery result, i.e. winning or blank, on the display device 14. If the server 20 sends audio data or speech data together with the above mentioned notification, the terminal 10 drives the speaker 16 in accordance with the sent audio data or speech data when the lottery result is displayed on the display device 14.

It is to be understood that the above description is intended to be illustrative and not restrictive. Many embodiments and the combinations thereof will be apparent to those of skill in the art upon reviewing the above description. For example, the above-mentioned transaction is compliant with HTTP and is carried out on Web system, but the present invention is not so limited. Those skilled in the ant will recognize other equivalent of Internet services, such as an E-mail service. With E-mail service, when the menu of lotteries is sent from the server 20 to the terminal, the mailer program executed by the processor 11 provides the menu on the display device 14. Then the purchase offer is also sent via E-mail with fixed form to the server 20. The server 20 cuts texts out of the purchase offer, in relation with the types of lotteries and the numbers of purchased sheets, so as to carries out the random sampling and the determination of the winning lottery in the manner as mentioned above. In addition, the identification of the terminal is the IP address, but the present invention is not so limited, For example, the identification may be a telephone number of the purchaser, which is assigned for the mobile terminal in the case where the mobile terminal is a cellular phone.

This application is based on Japanese Patent Application filed on Apr. 20, 2000, No. Hei 2000-119521, which are incorporated herein by reference.

What is claimed is:

1. A method of processing data on a server which exists on a communication network and performs as an automated lottery machine, the server being connected with a terminal of a purchaser through the communication network, the server having a memory, the terminal having an identification unique on the communication network, the method comprising the steps of:
responsive to access from the terminal to the server, obtaining the identification of the terminal to store the identification in the memory;
transmitting a menu of lotteries to the terminal to stimulate the purchaser to purchase a lottery;
receiving a purchase offer from the terminal, the purchase offer being determined by the purchaser in accordance with the menu and indicating a lottery which the purchaser wants to purchase;
judging whether the lottery specified by the purchase offer is a winning lottery or a blank lottery; and
notifying the terminal of a judgement of the lottery.

2. A data processing method as claimed in claim 1, wherein the communication network stands on TCP/IP stacks, the identification being an IP address assigned to the terminal.

3. A data processing method as claimed in claim 1, wherein the terminal is a mobile terminal with telephony function and has a telephone number as the identification.

4. A data processing method as claimed in claim 1, wherein all of the steps are executed in on-line processing.

5. A method of processing data on a server which exists on a communication network and performs as an automated lottery machine, the server being connected with a terminal of a purchaser through the communication network, the server having a memory, the terminal having an identification unique on the communication network, the method comprising the steps of:
responsive to access from the terminal to the server, obtaining the identification of the terminal to store the identification in the memory;
transmitting a menu of lotteries to the terminal to stimulate the purchaser to purchase a lottery;
receiving a purchase offer from the terminal, the purchase offer being determined by the purchaser in accordance with the menu and indicating a lottery which the purchaser wants to purchase;
carrying out random sampling on the basis of predetermined distribution to generate a specific number for the lottery specified by the purchase offer;
determining that the lottery is a winning lottery when the specific number meets a condition predefined for the predetermined distribution, while the lottery is a blank lottery when the specific number does not meets the predefined condition; and
notifying the terminal whether the lottery is the winning lottery or the blank lottery.

6. A server existing on a communication network and serving as an automated lottery machine, the server being connected with a terminal of a purchaser through the communication network, the terminal having an identification unique on the communication network, said server comprising:
a processor, and
a memory including software instructions adapted to enable said processor to cause the server to perform:
responsive to access from the terminal to the server, obtaining the identification of the terminal to store the identification in the memory;
transmitting a menu of lotteries to the terminal to stimulate the purchaser to purchase a lottery;
receiving a purchase offer from the terminal, the purchase offer being determined by the purchaser in accordance with the menu and indicating a lottery which the purchaser wants to purchase;
judging whether the lottery specified by the purchase offer is a winning lottery or a blank lottery; and
notifying the terminal of a judgement of the lottery.

7. A server as claimed in claim 6, wherein the communication network stands on TCP/IP stacks, the identification being an IP address assigned to the terminal.

8. A server as claimed in claim 6, wherein the terminal is a mobile terminal with telephony function and has a telephone number as the identification.

9. A data processing method as claimed in claim 6, wherein the software instructions are executed in on-line processing.

10. A server existing on a communication network and serving as an automated lottery machine, the server being connected with a terminal of a purchaser through the communication network, the terminal having an identification unique on the communication network, said server comprising:
a processor, and
a memory including software instructions adapted to enable said processor to cause the server to perform:
responsive to access from the terminal to the server, obtaining the identification of the terminal to store the identification in the memory;
transmitting a menu of lotteries to the terminal to stimulate the purchaser to purchase a lottery;
receiving a purchase offer from the terminal, the purchase offer being determined by the purchaser in accordance with the menu and indicating a lottery which the purchaser wants to purchase;
carrying out random sampling on the basis of predetermined distribution to generate a specific number for the lottery specified by the purchase offer;
determining that the lottery is a winning lottery when the specific number meets a condition predefined for the predetermined distribution, while the lottery is a blank lottery when the specific number does not meets the predefined condition; and
notifying the terminal whether the lottery is the winning lottery or the blank lottery.

11. A computer program product for enabling a processor to work as a server which exists on a communication network and which serves as an automated lottery machine, the server being connected with a terminal of a purchaser through the communication network and having a memory, the terminal having an identification unique on the communication network, said computer program product comprising software instructions for enabling the processor to perform predetermined operations, the predetermined operations including:
responsive to access from the terminal to the server, obtaining the identification of the terminal to store the identification in the memory;
transmitting a menu of lotteries to the terminal to stimulate the purchaser to purchase a lottery;
receiving a purchase offer from the terminal, the purchase offer being determined by the purchaser in accordance with the menu and indicating a lottery which the purchaser wants to purchase;
judging whether the lottery specified by the purchase offer is a winning lottery or a blank lottery; and
notifying the terminal of a judgement of the lottery.

12. A computer program product as claimed in claim 11, wherein the communication network stands on TCP/IP stacks, the identification being an IP address assigned to the terminal.

13. A computer program product as claimed in claim 11, wherein the terminal is a mobile terminal with telephony function and has a telephone number as the identification.

14. A computer program product as claimed in claim 11, wherein the software instructions are executed in on-line processing.

15. A computer program product for enabling a processor to work as a server which exists on a communication network and which serves as an automated lottery machine, the server being connected with a terminal of a purchaser through the communication network and having a memory, the terminal having an identification unique on the communication network, said computer program product comprising software instructions for enabling the processor to perform predetermined operations, the predetermined operations including:
responsive to access from the terminal to the server, obtaining the identification of the terminal to store the identification in the memory;
transmitting a menu of lotteries to the terminal to stimulate the purchaser to purchase a lottery;
receiving a purchase offer from the terminal, the purchase offer being determined by the purchaser in accordance with the menu and indicating a lottery which the purchaser wants to purchase;
carrying out random sampling on the basis of predetermined distribution to generate a specific number for the lottery specified by the purchase offer;
determining that the lottery is a winning lottery when the specific number meets a condition predefined for the predetermined distribution, while the lottery is a blank lottery when the specific number does not meets the predefined condition; and
notifying the terminal whether the lottery is the winning lottery or the blank lottery.
